(19) United States
(12) Patent Application Publication
(10) Pub. No.: US 2015/0300868 A1
(43) Pub. Date: Oct. 22, 2015

(54) APPARATUSES AND METHODS FOR FUEL LEVEL SENSING

(71) Applicant: Deringer-Ney, Inc., Bloomfield, CT (US)

(72) Inventor: Joseph Scott Smyers, Chardon, OH (US)

(21) Appl. No.: 14/255,692

(22) Filed: Apr. 17, 2014

(51) Int. Cl. G01F 23/34

(52) U.S. Cl. CPC G01F 23/34

(57) ABSTRACT

Apparatuses and methods for fuel level sensing use a rotatable housing, an interior arm suspended on an axle within the housing, a counterweight joined to one end of the interior arm and a position sensor with first and second sensor elements. The sensor elements are arranged within the housing with one of the sensor elements is joined to an interior wall of the housing and the other joined to the interior arm such that the sensor elements are rotatable relative to one another. An exterior arm joined to an exterior of the housing is adapted to accommodate a float. The exterior arm slaves the rotatable housing in rotation about a rotational axis, and relative rotation of the first and second sensor elements may cause a change in a sensor output of the position sensor.

### TECHNICAL FIELD

Implementations of the present disclosure relate generally to fuel level sensors, and more particularly to fuel level sensors with a rotatable housing defining an enclosed interior adapted to protect fuel level sensor elements from fuel within a fuel tank.

### BACKGROUND

Fuel level sensors are commonly used to determine fuel levels of a fuel tank. Some of these devices comprise fuel level sensors, where particular components of a fuel level sensor are enclosed in a housing to prevent the components from being directly exposed to fuel of the fuel tank. Many fuel level sensors rely on the position of an external float arm to determine fuel level of a fuel tank, where typically, each angle of the float arm is known to correspond to a particular fuel level.

In particular, determining a fuel level requires communicating a position of the float arm to a sensor located in the housing. Effectively communicating float arm positions in this manner has been proven to be a challenging task, however. Known approaches of providing float arm positions have led to a multitude of reliability issues, including leakage, poor durability, and inaccurate measurement.

### SUMMARY OF THE DISCLOSURE

A sensor assembly includes a rotatable housing with an axle and an enclosed interior defined by walls of the housing. An interior arm may be suspended on the axle, and a counterweight may be joined to one end of the interior arm. A position sensor includes a first sensor element and a second sensor element arranged within the interior of the housing. One of the sensor elements may be joined to an interior wall of the housing, while the other of the sensor elements may be joined to the interior arm such that the sensor elements are rotatable relative to one another. The sensor assembly additionally includes an exterior arm joined to an exterior of the housing proximate the axle and adapted to accommodate a float. The exterior arm slaves the rotatable housing in rotation about a rotational axis extending through the axle, and relative rotation of the first and second sensor elements causes a change in a sensor output of the position sensor.

According to another implementation, a fuel level sensor includes a rotatable housing rotatable about an axis and a sensor assembly disposed within the housing. The sensor assembly includes a first sensor element and a second sensor element, which are rotatable relative to one another as a float arm joined to the exterior of the rotatable housing changes position in response to changes in a fuel level within a fuel tank.

According to yet another implementation, a method of sensing fuel levels in a fuel tank involves providing a fuel sensor, which includes a rotatable housing comprising an axle and an enclosed interior defined by walls of the housing. Within the housing is an interior arm suspended on the axle, a counterweight joined to one end of the interior arm, and a resistance sensor with first and second sensor elements. One of the sensor elements may be joined to an interior wall of the housing, while the other of the sensor elements may be joined to the interior arm such that the sensor elements are rotatable relative to one another. A fuel level in the fuel tank may be sensed by detecting a change in resistance due to relative rotation of the sensor elements.

### BRIEF DESCRIPTION OF THE DRAWINGS

FIG. 1 is a schematic diagram of a fuel level sensor in a first position according to an embodiment of the present disclosure.

FIG. 2 is a schematic diagram of the fuel level sensor if FIG. 1 in a second position according to an embodiment of the present disclosure.

FIG. 3 is a schematic diagram of the fuel level sensor of FIG. 1 in a third position according to an embodiment of the present disclosure.

FIG. 4 is a schematic diagram of a fuel level sensor according to another embodiment of the present disclosure.

FIG. 5 is an isometric diagram of the fuel level sensor of FIG. 4 according to an embodiment of the present disclosure.

### DETAILED DESCRIPTION

Apparatuses and methods for fuel level sensing are disclosed herein. Certain details are set forth below to provide a sufficient understanding of embodiments of the present disclosure. However, it will be clear to one having skill in the art that implementations may be practiced with or without these particular details. Moreover, the particular embodiments of the present disclosure are provided by way of example and should not be construed as limiting. In other instances, well-known components, circuits, and operations have not been shown in detail as being known to those of skill in the art.

The present disclosure is directed generally to fuel level sensors. A fuel level sensor may be a sensor located in a fuel tank configured to provide one or more signals indicative of fuel levels of the fuel tank. A fuel sensor may, for instance, include a resistive card and a contact (e.g., electrical contact). Generally, the resistive card includes a resistive network (e.g., a one or more resistive or conductive traces), and during operation, the contact may slide along a portion of the resistive network. In this manner, a resistance provided by the resistive network may vary, for instance, based on fuel level. By way of example, when a fuel level is relatively low, the contact may provide an electrical path such that the fuel level sensor has a low resistive output, and when a fuel level is relatively high, the contact may provide an electrical path such that the fuel level sensor has a higher resistive output, or vice versa. Associating each resistance with a particular fuel level may be achieved using an external control logic coupled to an electrical output of the resistive card. In prior approaches to sealing fuel level sensors, problems typically arise when the sensor is exposed to fuel leakage proximate rotary seals where a float arm enters the interior of the fuel level sensor, and the contact and/or the resistive film on the card tends to degrade, which leads to eventual failure of the sensor. It has been discovered that the fuel level sensor assemblies of the present disclosure remove the need for a rotary seal and may protect the sensor elements from contact with fuel, thereby providing a fuel level sensor that resists degradation caused by fuel ingress.

Briefly, the fuel level sensor of the present disclosure may be used to sense a fuel level of a fuel tank by displacement of a sealed housing the fuel level sensor in response to changes in fuel level. Upon displacement of the housing, the housing may be arranged at a particular angle relative to a wiper arm the fuel level sensor, which hangs by gravity from an axle within the sealed housing. Because components of a conductive path of the fuel level sensor assembly are associated with both the housing and the wiper arm, a resistance of the conductive path changes with the changing angle of the housing, and an external circuit may determine the resistance of the conductive path and therefore the fuel level. Further, the components providing the conductive path (e.g., sensor elements and resistive traces) are protected by the sealed housing, thereby providing a more robust and durable fuel level sensor assembly.

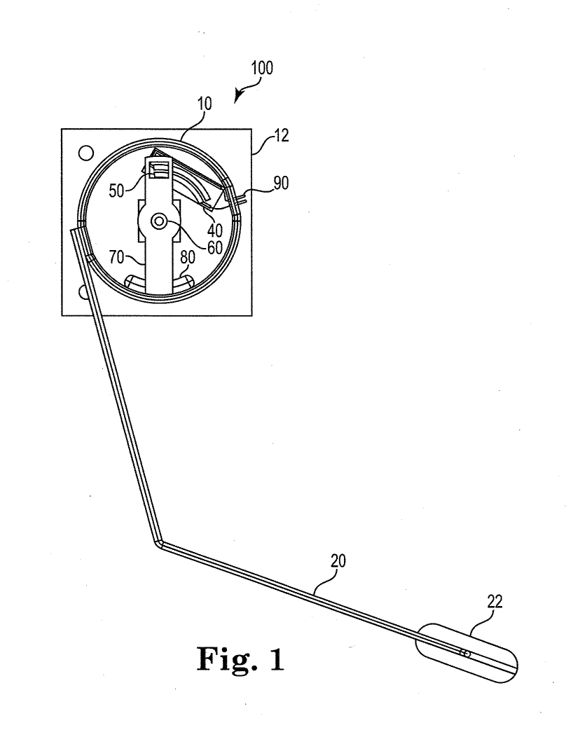

FIG. 1 is a schematic diagram of a fuel level sensor in a first position according to one implementation. The fuel level sensor assembly 100 includes a rotatable housing 10, a plate assembly 12, a float arm 20 including an external float 22, a resistive card 40, a contact 50, an axle 60, a wiper arm 70, a counterweight 80, and output contacts 90.

The rotatable housing 10 may be substantially cylindrical (e.g., elliptically cylindrical) in shape. For example, the rotatable housing may be configured as a shortened cylinder and its shape may be likened to a puck or a biscuit. The housing 10 may include sidewalls arranged between opposing circular-shaped front and back walls. The sidewalls may define an outer circumferential wall, and in some instances, a portion of the outer circumferential wall of the rotatable housing 10 may include one or more relatively linear portions. The one or more portions may be used, for instance, to couple the float arm 20 to the rotatable housing 10 and/or to provide an egress for the output contacts 90. The rotatable housing 10 may be constructed of any material known in the art, now or in the future, including glass, plastic, metal, rubber, or any combination thereof, and accordingly may be configured to resist and/or mitigate corrosion from one or more liquid fuels.

The rotatable housing 10 may be sealed using laser welding, injection of a sealing polymer, compression of an O-ring seal, or a combination thereof. Accordingly, the rotatable housing 10 may be liquid tight and/or filled with a viscous fluid. Where the rotatable housing 10 is filled with a viscous fluid, debris or other contaminants that would otherwise accumulate between components of the rotatable housing 10 may be prevented from doing so. For example, contact between the resistive card 40 and the contact 50, described further below, may be improved as a result of the rotatable housing 10 being filled with the viscous fluid. In some instances, the viscous fluid may further act as a lubricant for one or more of the components of the sensor 100. In at least one example, the viscous fluid may be an inert fluid, a dielectric fluid, or any combination thereof. In some examples, the rotatable housing 10 may only be partially filled with the viscous fluid, and any portion of the rotatable housing 10 not filled with the non-conductive fluid may be filled with an inert gas, such as argon or nitrogen. In some examples, the non-conductive fluid may not chemically react with components of the fuel level sensor 100, including the housing 10, the resistive card 40, and the contact 50.

The plate assembly 12 may be coupled to the rotatable housing 10 such that the plate assembly 12 circumferentially encloses at least a portion of the rotatable housing 10 to enable the rotatable housing 10 to rotate within the plate assembly 12. A portion of the plate assembly 12 may be fixed to an interior surface (e.g., vertical interior surface) of a fuel tank, thereby holding the rotatable housing 10 within the fuel tank. In some examples, the plate assembly 12 may be fixed within a fuel pump module, or may be fixed to a bracket located within the fuel tank. The plate assembly, thus, may prevent the rotatable housing 10 from being displaced relative to the fuel tank, yet still allow the rotatable housing 10 to rotate as described herein.

The float arm 20 may be joined to the rotatable housing 10 and the float arm 20 may be configured to change position in response to changes in fuel level within fuel tank, resulting in rotation of the rotatable housing 10, and thus operation of the fuel level sensor, described below. The float arm 20 may include a buoyant float 22 that rises and falls with the fuel level of the fuel tank thereby causing the float arm 20 to rise and fall in response. With reference to FIG. 1, in some examples, the float arm 20 may be coupled to the exterior edge of the rotatable housing 10. In other examples, the float arm 20 may be coupled to an axle extending from the rotatable housing 10 or a flat portion of the rotatable housing 10.

Arranged within the sealed housing 10 are the position sensing elements including the resistive card 40 and the contact 50, along with the axle 60, the counterweight 80 and the wiper arm 70; and due to their arrangement within the sealed housing 10, each of the aforementioned components of the fuel level sensor assembly 100 may be protected from contact with fuel.

A resistive network of the resistive card 40 may be configured to provide any range and/or resolution of resistances. The resistive card 40 may, for instance, use any manner of filler, layout, and firing schedule to achieve a particular sheet resistance (e.g., as measured in ohms/sq). The resistive network of the resistive card 40 may comprise resistors, traces, voltage controlled resistive elements (e.g., transistors), a combination thereof, or any other resistive elements known in the art. In some examples, the resistive network of the resistive card 40 may include a trace comprising polymeric ink and implemented (e.g., fired) on any number of substrates. For example, polymeric ink may be printed (e.g., directly printed) on the housing, on an FR-4 board, on a kapton tape, on a ceramic substrate, or combinations thereof. In some examples, the polymeric ink may be used to implement a single resistive trace or implement a dual resistive trace and the contact 50 may be configured to interface directly with the polymeric ink.

In some embodiments, such as those for use in high vibration or otherwise aggressive environments, a trace of the resistive card 40 may be implemented using cermet-type ink. The cermet-type ink may, for instance, be used in lieu of the polymeric ink. In these instances, the substrate may include ceramic, glass and/or porcelain-coated metal configured to withstand firing temperatures associated with cermet-type ink. In some examples, the resistive properties of the cermet-type ink may be controlled by varying the amount of ruthenium oxide or other high temperature oxides included in the cermet-type ink. Amounts of oxides may be varied, for instance, prior to firing the cermet-type ink. When using cermet-type inks, the resistive network of the resistive card 40 may further be implemented using a number of closely packed, but electrically separated, shunts that extend out from the resistive network. These shunts may be implemented using a highly conductive, low wearing metallic ink, such as a Pd—Ag or Au based alloy. The contact 50 may interface with the shunts and provide a stepwise resistance and/or voltage output. This approach may be implemented using either single resistive trace or dual resistive trace configurations.

In some examples, the resistive card 40 may be affixed to an interior surface of the rotatable housing 10 and may rotate in unison with the rotatable housing 10 about the axle 60. The resistive card 40 may be coupled to the output contacts 90, for instance, by one or more wires, such that an adjustable resistance may be provided via a conductive path between the output contacts 90.

The contact 50 may comprise an electrically conductive contact and may be configured for either single or dual resistive trace configurations. For one or more single resistive trace configurations, the resistive network of the resistive card 40 may provide a conductive path extending from a first contact 90 to the contact 50 along the resistive trace, and further extending from the contact 50 to a second contact 90. In some examples, the contact 50 may include a sliding or rolling component to assist in moving the contact 50 along the resistive trace. In some examples, the output contacts 90 may be located on different sides of the rotatable housing 10 and/or may be located along the axis 60 to minimize resistance to the torque applied by the float arm 20 during operation. In other examples, the output contacts 90 may be located away from the axis 60 and a strain relief technique may be used on the wires exiting from the contact 90 to reduce torque from the external wire rotation.

In one or more dual resistive trace configurations, a trace, such as a low wear trace, may be placed adjacent to the resistive trace on the resistive card 40 and may be either continuous or segmented. Accordingly, the contact 50 may be configured to electrically couple the adjacent traces on the resistive card 40. In particular, the contact 50 may comprise a shunt, nugget, rake, knuckle, brush, ball, spring geometry, or any combination thereof, and may be configured to electrically couple the adjacent traces at any given time via either a sliding or rolling motion. For example, the contact 50 may be coupled to the wiper arm 70 and in contact with the adjacent traces of the resistive card 40 during operation at any given time. The contact 50 may be constructed of electrically conductive materials including metals and metallic alloys. Suitable metals may include but are not limited to gold. Suitable metallic alloys may include, but are not limited to, Pd-based alloys, such as Paliney series alloys (e.g., Paliney 6, Paliney 7), gold-based alloys (e.g., Neyoro G), copper-based alloys (e.g., Cu—Ni alloys, Cu—Ni—Zn alloys), and various electroplated contact materials, such as Au, Pd, Ag, and/or Ni plated surfaces. Thus, the conductive path may be provided between the output contacts 90 using traces of the resistive network of the resistive card 40. In some examples, the conductive path may extend from a first contact 90 to a first trace, proceed along the first trace to a second trace via the contact 50, and further proceed from the second trace to a second contact 90. The resistance of the conductive path may vary based on the point at which the contact 50 couples the first and second traces. As described, the output contacts 90 may be located on any side of the housing 10 or along the rotation axis 60.

The axle 60 may be integrally formed by the rotatable housing 10 such that rotation of the housing 10 results in rotation of the axle 60. Alternatively, the axle may non-rotatably extend from the plate assembly 12 through an opening defined by walls of the rotatable housing 10 so that the rotatable housing 10 rotates about the axle 60, with the housing 10 sealed by the walls defining the opening. In either case, the axle 60 may be disposed through a central axis of the rotatable housing 10 to enable the rotatable housing 10 to rotate about its central axis. In other examples, the axle 60 may be offset relative to the central axis of the rotatable housing, and/or may be coupled to an exterior surface of the rotatable housing 10.

The wiper arm 70 may be coupled to the contact 50 and may position the contact 50 so that it opposes the resistive card 40. In at least one embodiment, the contact 50 may be coupled to an end of the wiper arm 70 opposite the counterweight 80, and as a result, the contact 50 may be held in a substantially stationary position during operation of the fuel level sensor assembly 100. In addition, the wiper arm 70 may be coupled to the axle 60 so that the wiper arm 70 hangs by gravity from the axle, described below. In particular, the wiper arm 70 is rotatable about the axle 60, and rotation of the wiper arm 70 may be independent of the rotation of the rotatable housing 10 and the resistive card 40 when coupled thereto.

The counterweight 80 may comprise one or more weights and may be coupled to the wiper arm 70. The counterweight 80, in combination with the wiper arm 70, may act as a weighted pendulum to cause the wiper arm 70 to be substantially stationary during operation. The wiper arm 70 may therefore be held in substantially a same position, such as a substantially vertical position. In other embodiments, the counterweight 80 may be configured to hold the wiper arm 70 in any other position (e.g., substantially horizontal). Generally, as used herein, “substantially stationary” may refer to the tendency of a component, such as the wiper arm 70, to stay in a settled position (e.g., as a result of gravity) and/or return to the settled position after being disturbed by either an external force or rotation of the rotatable housing 10.

In some examples, the fuel sensor 100 may regulate the rotation of the wiper arm 70 and/or the counterweight 80. For example, in at least one embodiment, the rotatable housing 10 may include an alignment groove and the counterweight 80 may be aligned with the alignment groove. If the counterweight 80 is displaced (e.g., due to sloshing of fuel and/or movement of the fuel tank), it is displaced in accordance with the alignment groove. In another embodiment, the rotatable housing 10 may include one or more stops, or travel limiters, configured to limit a range at which the wiper arm 70 and/or the counterweight 80 may rotate about the axle 60. The stops may be located on the housing 10. In yet another example, the wiper arm 70 and the rotatable housing 10 may include magnets configured to stabilize the position of the wiper arm 70 during operation and/or reduce rotation of the wiper arm 70. For instance, the magnet(s) may be located outside the housing 10 and may be employed to attract a corresponding magnet located on the counterweight 80. In this manner, the magnets may serve to attract the counterweight 80 to a settled position or repel the counterweight 80 from unsettled positions.

In some examples, rotation of the wiper arm 70 and/or the counterweight 80 may be controlled using wheels and/or bearings. In at least one embodiment, the counterweight 80 may be aligned with the alignment groove using a wheel or bearing. In another embodiment, the wiper arm 70 and/or the counterweight 80 may include one or more wheels or bearings configured to roll on an interior surface of the rotatable housing 10 and maintain the distance between the wiper arm 70 and the resistive card 40.

Because the output contacts 90 may extend from an exterior of the rotatable housing 10 to the resistive card 40, electrical coupling of the resistive card 40 to the output contacts 90 may comprise flexible wiring configured to mitigate and/or resist wear resulting from rotation of the rotatable housing 10. The wiring may further be configured to resist deterioration and/or damage resulting from exposure to fuel of the fuel tank.

In operation, the fuel level sensor assembly 100 may generally be used in connection with determining a fuel level in a fuel tank. As the float arm 20 rises and falls with respective fuel levels, the rotatable housing 10 may be slaved in rotation relative to the plate assembly 12. For example, the rotatable housing 10 may rotate in a first direction (e.g., clockwise) responsive to the float arm 20 falling, and may rotate in a second direction (e.g., counter-clockwise) responsive to the float arm 20 rising, and the fuel level sensor components within the sealed housing 10 operate in response to such movement of the float arm 20.

In an example operation of the fuel level sensor assembly 100, a fuel level of a fuel tank may be at a particular level, and as described, the float arm 20 may be displaced at particular height based on the fuel level. Thus the rotatable housing 10 coupled to the float arm 20 may be at a particular angle relative to the wiper arm 70, which due to its coupling to the counterweight 80, hangs by gravity from the axle 60. In this example, the resistive card 40 is coupled to the rotatable housing 10 and may thus be at a particular angle relative to the wiper arm 70. Accordingly, the contact 50 may electrically couple the resistive and conductive traces on the resistive card 40 such that the conductive path between the output contacts 90 has a resistance corresponding to the fuel level. An external circuit coupled to the output contacts 90 of the fuel level sensor assembly 100 may determine the resistance of the conductive path between the output contacts 90, and based on the resistance of the conductive path, may determine the fuel level.

As the fuel level of the fuel tank changes, the height of the float arm 20 may change as well, and the float arm 20 may rotate the rotatable housing 10 relative to the plate assembly 12 in accordance with the change in fuel level. This rotation may change the orientation of the rotatable housing 10, and thereby change the position of the resistive card 40 relative to the contact 50 (recall that the contact 50 is substantially stationary). While rotating the resistive card 40 may generate a frictional force between the contact 50 and the resistive card 40, the weight of the counterweight 80 may be sufficient to overcome the frictional force and maintain the position of the contact 50. The change in position of the resistive card 40 relative to the contact 50 may cause the contact 50 to interface with a different portion of the resistive card 40. Accordingly, the resistance of the conductive path between the output contacts 90 may change. As the output contacts 90 may be coupled to an external circuit, described above, the resistance of the conductive path of the resistive card 40 may be used to indicate the new fuel level of the fuel tank.

As described, the contact 50 may slide along the resistive elements of the resistive card 40 to provide a change in the measured resistance. In this manner, the resistive card 40 and the contact 50 may operate as a potentiometer. In other embodiments, other components, such as a magnetic sensor, may be used in lieu of the resistive card 40 and the contact 50. For example, a Hall effect sensor and corresponding magnet may be used to provide a resistance, current, and/or voltage indicative of fuel level.

In other examples, wires need not be provided out of the housing 10 to the output contacts 90 and/or the output contacts 90 may be omitted. For instance, signals indicative of fuel levels may be provided from the rotatable housing 10 using wireless communication. Power for such communications may be generated using a battery and/or from motion of the wiper arm 70 and/or counterweight 80 during operation.

While the contact 50 has been described herein as being located on an end of the wiper arm 70 opposite the counterweight 80 and proximate the resistive card 40, in at least one embodiment, the resistive card 40 may be located proximate the counterweight 80 and the contact 50 may be located on the counterweight 80. This may, for instance, allow for a smaller wiper arm 70 and a reduction in material costs.

With reference to FIG. 1, the fuel level sensor assembly 100 is shown in a position in an instance in which a fuel tank has a low fuel level (e.g., the fuel tank is empty or near empty). Due to the low fuel level, the angle of the rotatable housing 10 may such that the resistive card has been rotated clockwise (e.g., 15 degrees clockwise) and the contact 50 is electrically coupling resistive elements of a first end of the resistive card 40. Coupling resistive elements in this manner may cause the resistive card 40 to provide a resistance corresponding to a low fuel level. By way of example, the resistive card 40 may provide a relatively low resistance to indicate the low fuel level.

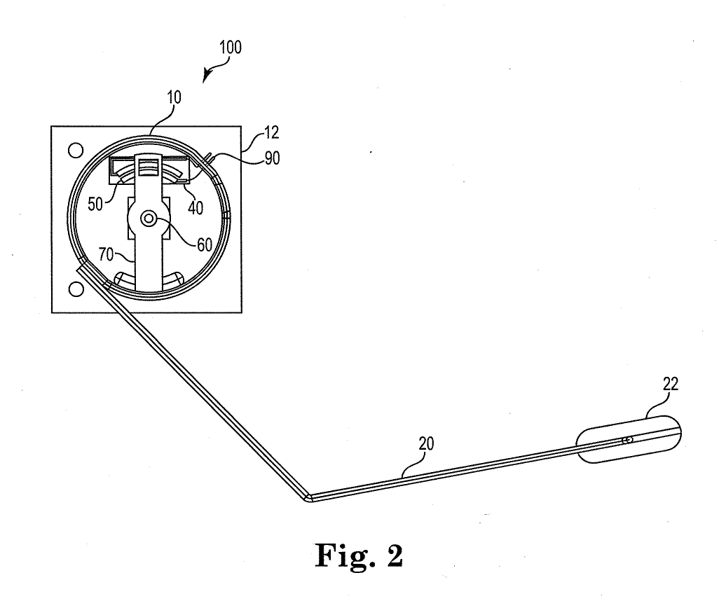

With reference to FIG. 2, the fuel level sensor assembly 100 is shown in a position in an instance in which a fuel tank has a moderate fuel level (e.g., the fuel tank is approximately half full). Due to the moderate fuel level, the angle of the rotatable housing 10 may be such that the resistive card is in a neutral position (e.g., vertically centered) and the contact 50 is electrically coupling resistive elements near the center of the resistive card 40. Coupling resistive elements in this manner may cause the resistive card 40 to provide a resistance corresponding to a moderate fuel level. By way of example, the resistive card 40 may provide a moderate resistance to indicate the moderate fuel level.

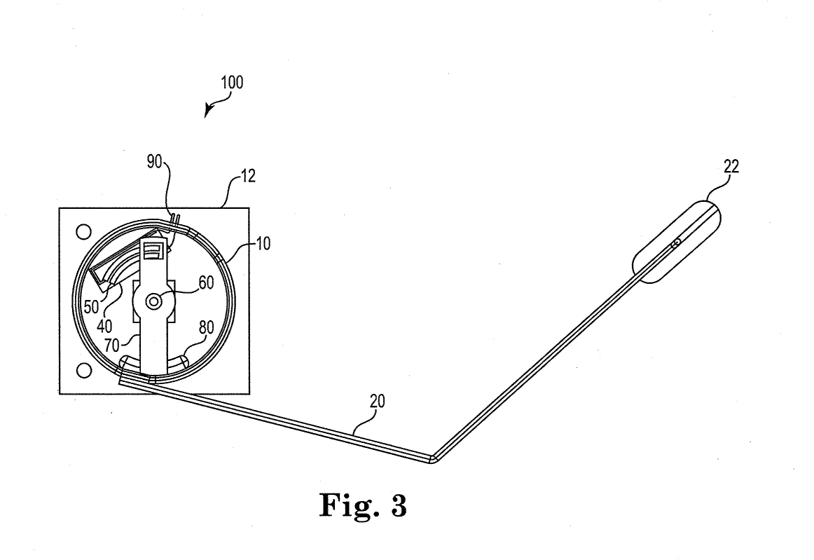

With reference to FIG. 3, the fuel level sensor assembly 100 is shown in a position in an instance in which a fuel tank has a high fuel level (e.g., the fuel tank is near full or full). Due to the high fuel level, the angle of the rotatable housing 10 may be such that the resistive card has been rotated counter-clockwise (e.g., 15 degrees counter-clockwise) and the contact 50 is electrically coupling resistive elements of a second end of the resistive card 40 opposite the first end. Coupling resistive elements in this manner may cause the resistive card 40 to provide a resistance corresponding to a high fuel level. By way of example, the resistive card 40 may provide a relatively high resistance to indicate the high fuel level.

While the range of angles at which the resistive card 40 may be titled discussed with respect to FIGS. 1-3 spans from approximately 15 degrees counter-clockwise to 15 degrees clockwise, in some examples, the fuel level sensor assembly 100 may operate over any range. For example, the resistive card 40 may be tilted between 30 degrees clockwise and 30 degrees counter-clockwise, or may be tilted between 45 degrees clockwise and 45 degrees counter-clockwise. Moreover, the range over which the resistive card 40 operates need not be symmetric. By way of example, the resistive card 40 may be configured to tilt between 15 degrees clockwise and 30 degrees counter-clockwise. It will be appreciated by those having ordinary skill in the art that other embodiments may be implemented without departing from the scope of the present disclosure. Additionally, while operation has been described herein with respect to resistance increasing as the resistive card 40 is rotated in a counter-clockwise direction, in some examples resistance may vary in other ways. Resistance may increase, for instance, as the resistive card 40 is rotated in a clockwise direction.

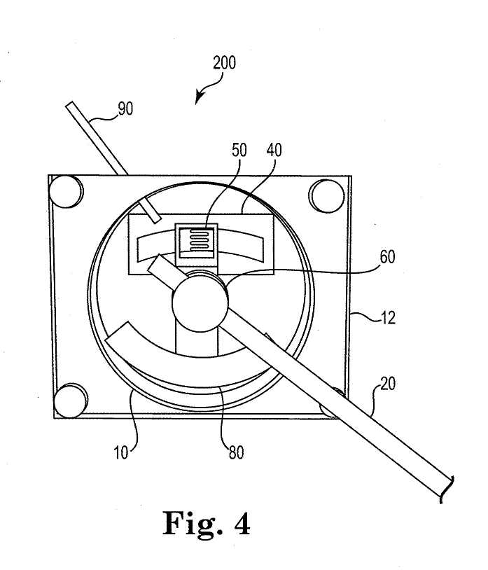

FIG. 4 is a schematic diagram of a fuel level sensor assembly 200 according to an embodiment of the present disclosure. The fuel level sensor assembly 200 includes elements that have been previously described with respect to the fuel level sensor assembly 100 of FIGS. 1-3. Those elements have been shown in FIG. 4 using the same reference numbers used in FIGS. 1-3 and operation of the common elements is as previously described. Consequently, a detailed description of the operation of these elements will not be repeated in the interest of brevity.

As described, in some examples the float arm 20 may be coupled to the axle 60. Thus, the float arm 20 of the fuel level sensor assembly 200 may be coupled to the axle 60 and may be configured to rotate the rotatable housing 10 during operation by applying a torque to the axle 60 in accordance with fuel levels of a fuel tank. By way of example, the float aim 20 may apply a counter-clockwise torque to the axle 60 in response to a fuel level increasing and may apply a clockwise torque to the axle 60 in response to the fuel level decreasing. In some examples, the float arm 20 may be coupled to an axle (not shown in FIG. 4) that is collinear with the axle 60 and coupled to the axle 60 such that the axles rotate in unison.

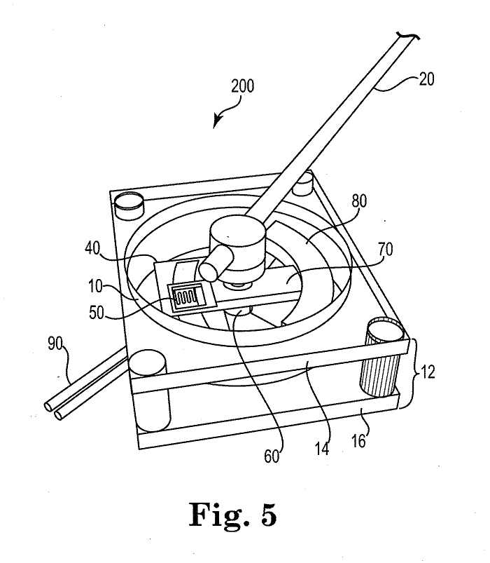

FIG. 5 is an isometric diagram of the fuel level sensor assembly 200 according to an embodiment of the present disclosure. The fuel level sensor assembly 200 includes elements that have been previously described with respect to FIG. 4 Those elements have been shown in FIG. 5 using the same reference numbers used in FIGS. 4 and operation of the common elements is as previously described. Consequently, a detailed description of the operation of these elements will not be repeated in the interest of brevity.

The plate assembly 12 of the fuel level sensor assembly 200 may include a cover plate 14 and a base plate 16. The cover plate 14 and the base plate 16 may be fixedly joined by one or more fasteners as illustrated. The cover plate 14 and the base plate 16 of the fuel level sensor assembly 200 may be used to implement the plate assembly 12 of the fuel level sensor assembly 100.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. A sensor assembly, comprising:
a rotatable housing comprising an axle and an enclosed interior defined by walls of the housing;
an interior arm suspended on the axle and arranged within the enclosed interior of the housing;
a counterweight joined to one end of the interior arm;
a position sensor comprising a first sensor element and a second sensor element, the sensor elements arranged within the interior of the housing, with one of the sensor elements joined to an interior wall of the housing and the other of the sensor elements joined to the interior arm such that the sensor elements are rotatable relative to one another; and
an exterior arm joined to an exterior of the housing proximate the axle and adapted to accommodate a float;
wherein the exterior arm slaves the rotatable housing in rotation about a rotational axis extending through the axle, and relative rotation of the first and second sensor elements causes a change in a sensor output of the position sensor.

2. The assembly of claim 1, wherein the position sensor comprises a resistance sensor, wherein one of the sensor elements is configured as a sliding contact and the other of the sensor elements is configured as a resistive card, and wherein the change in the sensor output is a change in resistance sensed by the resistance sensor.

3. The assembly of claim 2, wherein the interior arm is configured as a wiper arm and carries the contact.

4. The assembly of claim 3, wherein the sliding contact is joined to the interior arm at an end opposite the end joined to the counterweight.

5. The assembly of claim 1, wherein the position sensor comprises a magnetic sensor, wherein one of the sensor elements is configured as a Hall effect sensor and the other of the sensor elements is configured as a magnet, and wherein the change in the sensor output is a changes in a magnetic field sensed by the magnetic field sensor.

6. The assembly of claim 1, wherein at least the first or second sensor element is electrically connected to an exterior of the housing.

7. The assembly of claim 1, further comprising a base plate adapted to join to the rotatable housing.

8. The assembly of claim 7, wherein the axle extends to an exterior of the housing and joins to the base plate.

9. The assembly of claim 7, further comprising a cover plate adapted to join to the base plate such that the rotatable housing is rotatable between and relative to the cover and base plates.

10. The assembly of claim 1, wherein the housing further comprises an alignment groove and the counterweight is adapted to be arranged in the alignment groove.

11. The assembly of claim 1, wherein the enclosed interior of the rotatable housing holds an inert fluid.

12. A fuel level sensor comprising a rotatable housing rotatable about an axis, a sensor assembly disposed within the housing and comprising a first sensor element and a second sensor element, the sensor elements rotatable relative to one another as a float arm joined to the exterior of the rotatable housing changes position in response to changes in a fuel level within a fuel tank.

13. The fuel level sensor of claim 12, wherein one of the sensor elements is joined to an interior wall of the housing and the other of the sensor elements joined to a counterweighted interior arm suspended on an axle within the enclosed interior of the housing such that upon rotation of the housing, the sensor element joined to the interior wall rotates with the housing and the sensor element joined to the counterweighted interior arm remains substantially stationary.

14. The fuel level sensor of claim 12, wherein the sensor assembly is configured as a resistive sensor and one of the sensor elements is configured as a sliding contact and the other of the sensor elements is configured as a resistive card.

15. The fuel level sensor of claim 14, wherein the interior arm is configured as a wiper arm and carries the contact.

16. The fuel level sensor of claim 15, wherein the contact is joined to the interior arm at an end opposite the end joined to the counterweight.

17. The fuel level sensor of claim 12, wherein at least the first or second sensor element is electrically connected to an exterior of the housing.

18. The fuel level sensor of claim 12, wherein the sensor assembly is configured as a magnetic sensor and one of the sensor elements is configured as a hall effect sensor and the other of the sensor elements is configured as a magnet.

19. A method of sensing fuel levels in a fuel tank, the method comprising:
providing a fuel sensor, the fuel sensor comprising:
a rotatable housing comprising an axle and an enclosed interior defined by walls of the housing;
an interior arm suspended on the axle and arranged within the enclosed interior of the housing;
a counterweight joined to one end of the interior arm;
a resistance sensor comprising a first sensor element and a second sensor element, the sensor elements arranged within the interior of the housing with one of the sensor elements joined to an interior wall of the housing and the other of the sensor elements joined to the interior arm such that the sensor elements are rotatable relative to one another; and
sensing a fuel level in the fuel tank based on detecting a change in resistance in response to relative rotation of the sensor elements.
